(19) United States
(12) Patent Application Publication
(10) Pub. No.: US 2026/0368313 A1
(43) Pub. Date: Nov. 19, 2026

(54) Protecting a Boolean Masked Addition Against Faults

(71) Applicant: Infineon Technologies AG, Neubiberg (DE)

(72) Inventor: Tim Fritzmann, Kissing (DE)

(21) Appl. No.: 19/678,456

(22) Filed: May 15, 2026

(30) Foreign Application Priority Data
May 16, 2025 (DE) 102025119161.1

(51) Int. Cl. G06F 21/55; G06F 21/60

(52) U.S. Cl. CPC G06F 21/552; G06F 21/602

(57) ABSTRACT

According to various embodiments, a data processing device is described comprising a Boolean masked addition processor configured to perform a Boolean masked addition and a fault protection circuit configured to generate a checksum for a first share, generate a second checksum-share, compare the first checksum-share with the second checksum-share and trigger a security measure in reaction to a mismatch between the first checksum-share and the second checksum-share.

### TECHNICAL FIELD

The present disclosure relates to data processing devices and methods for protecting a Boolean masked addition against faults.

### BACKGROUND

Large-scale quantum computers may potentially compromise traditional public-key cryptography. In response, standardization bodies like NIST (National Institute of Standards and Technology) actively investigate alternative cryptosystems and a new generation of cryptographic algorithms specifically designed to withstand quantum computer attacks. These algorithms facilitate a secure transition from classical to post-quantum cryptography. Lattice-based cryptography, a subclass of post-quantum cryptography, is particularly appealing due to its ability to offer a good balance between security, performance, and size.

Recently, NIST published the standards and/or specifications for three lattice-based cryptographic algorithms: one for key encapsulation (ML-KEM) and two for digital signatures (ML-DSA and FALCON). The next step of the transition to post-quantum cryptography requires secure implementation of these algorithms. Implementations must be particularly protected against side-channel and fault attacks. While countermeasures against side-channel attacks have been already explored, research on combining side-channel protection with fault protection is limited. Typically, side-channel countermeasures employ masking techniques which split secret variables into multiple additive or Boolean (XOR-based) shares. However, different parts of cryptographic algorithms are better suited to either the Boolean or arithmetic domains, necessitating efficient switching between the two. Typically, non-linear functions like sampling are more naturally suited to the Boolean domain, whereas the linear ring arithmetic operations are more efficiently performed in the arithmetic domain. The core operation for securely switching between Boolean and arithmetic masking is the secure Boolean masked addition (i.e. addition of Boolean masked integers). Moreover, the Boolean masked addition offers the advantage of enabling direct addition operations within the Boolean domain, thereby eliminating the need for transitions to the arithmetic domain for certain parts of lattice-based algorithms.

So, Boolean masked addition is a crucial operation in every masked implementation of lattice-based cryptography. It should therefore be protected against faults, e.g., fault attacks. For this, cost-efficient fault attack detection is of high relevance as the Boolean masked addition is already one of the performance bottlenecks. The main challenge in this can be seen in that the Boolean masked addition is non-linear and straightforward computations of checksums are not possible to protect this operation. Therefore, approaches for effective and efficient protection of Boolean masked addition against fault attacks is desirable.

### SUMMARY

According to various embodiments, a data processing device (e.g., a security device) is provided, comprising:
a Boolean masked addition processor configured to perform a Boolean masked addition of input values to generate a result value, wherein each input value has a bit for each bit position of a plurality of bit positions and is represented by a Boolean combination of two or more respective shares, the result value has a bit for each bit position of the plurality of bit positions and is represented by a Boolean combination of two or more respective shares and carry bits occurring in the addition are each represented by a Boolean combination of two or more respective shares and
a fault protection circuit configured to
   calculate, per bit position, a sum of the bits of the first shares of the input values and the bit of the first share of the result value and the first share of a carry bit modulo 2 and generate a first checksum-share by accumulating the calculated sums over the bit positions
   calculate, per bit position, a sum of the bits of the second shares of the input values and the bit of the second share of the result value and the second share of a carry bit modulo 2 and generate a second checksum-share by accumulating the calculated sums over the bit positions
   compare the first checksum-share with the second checksum-share and
   trigger a security measure in reaction to a mismatch between the first checksum-share and the second checksum-share.

### BRIEF DESCRIPTION OF THE FIGURES

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a processing device.

FIG. 2 illustrates an example how a secure AND may be implemented.

FIG. 3 shows an algorithm for bitslicing.

FIG. 4 shows an algorithm for Boolean masked addition.

FIG. 5 shows an algorithm for checksum calculation and checking.

FIG. 6 shows a flow diagram which illustrates the flow of an algorithm for performing fault-protected Boolean masked addition according to an embodiment.

FIG. 7 shows a hardware device for performing fault-protected Boolean masked addition as described above according to an embodiment.

FIG. 8 shows a flow diagram illustrating a method for protecting a Boolean masked addition against faults according to an embodiment.

### DETAILED DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

The examples described herein can be realized as instructions processed by a processor of a security device like a personal computer (with security measures), smart card, secure microcontroller, hardware root of trust, (embedded) secure element (ESE), Trusted Platform Module (TPM), or Hardware Security Module (HSM).

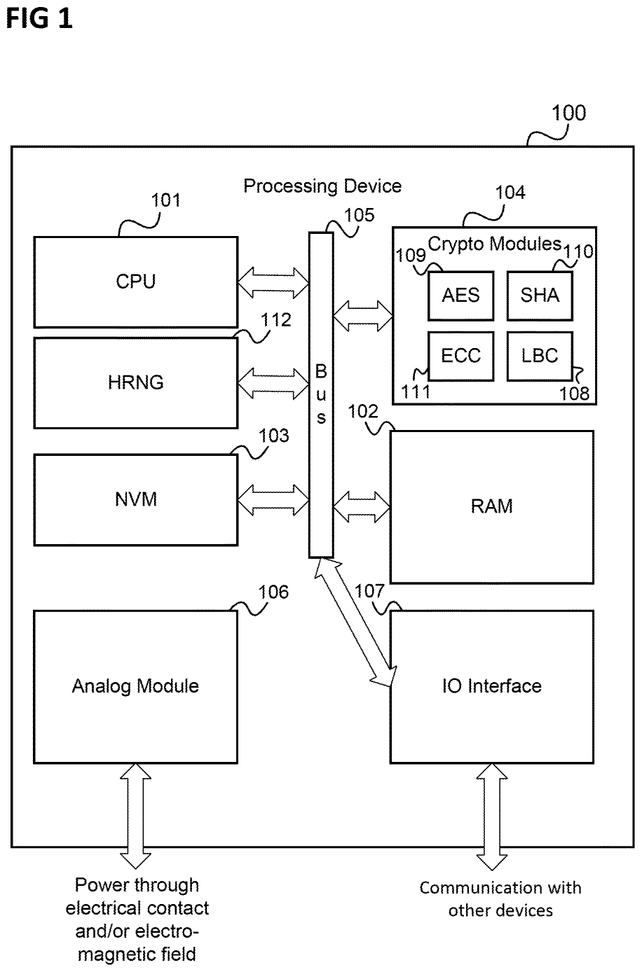

FIG. 1 shows an example for a processing device 100 comprising a CPU 101, a RAM 102, a non-volatile memory 103 (NVM), a crypto module 104, an analog module 106, an input/output interface 107 and a hardware-random number generator 112.

In this example, the CPU 101 (which may for example be an application processor) has access to at least one crypto module 104 (which may be part of a hardware security module) over a shared bus 105 to which each crypto module 104 is coupled. The shared bus is only an example and there may be individual interfaces between the various components. Each crypto module 104 may in particular comprise one or more crypto cores to perform certain cryptographic operations. Exemplary crypto cores are:
an AES core 109,
a SHA core 110,
an ECC core 111, and
a lattice-based crypto (LBC) core 108.

The lattice-based crypto core 108 may be provided in order to accelerate lattice-based cryptography.

The CPU 101, the hardware random number generator 112, the NVM 103, the crypto module 104, the RAM 102 and the input/output interface 107 are connected to the bus 105. The input/output interface 107 may have a connection to other devices, which may be similar to the processing device 100.

The analog module 106 is supplied with electrical power via an electrical contact and/or via an electromagnetic field. This power is supplied to drive the circuitry of the processing device 100 and may in particular allow the input/output interface to initiate and/or maintain connections to other devices.

The bus 105 itself may be masked or plain. Instructions for carrying out the processing and algorithms described in the following may in particular be stored in the NVM 103 and processed by the CPU 105. The data processed may be stored in the NVM 103 or in the RAM 102. Supporting functions may be provided by the crypto modules 104 (e.g., expansion of pseudo random data). Random numbers (e.g., for masks) are supplied by the hardware-random number generator 112.

The processing and algorithms described in the following may exclusively or at least partially be conducted on the crypto module 104, e.g., on the lattice-based crypto core 108 (although they may also be performed on CPU 101 in case there is no corresponding crypto module present on the processing device 100). A crypto module 104 may or may not be equipped with hardware-based security features. Such hardware-based security features could be circuits that implement countermeasures against side-channel power analysis or fault injection (e.g., using a laser). This in particular includes masking, i.e. splitting secret data into multiple shares. Such countermeasures can be realized by the use of randomness, redundant hardware, or redundant processing. In general, the goal of countermeasures is to disguise the internally processed values from an attacker who is able to observe the physical effect of the processing of such values.

To perform the procedures described in the following, instructions may be stored in the lattice-based crypto core 108 or they may be provided by the CPU 101 via the bus 105. Data may be stored locally within the lattice-based crypto core 108. It is also an option that the data is temporarily stored in the RAM 102 or the NVM 103. The lattice-based crypto core 108 may also use other crypto modules to provide supporting functions (e.g., expansion of pseudo random data). The lattice-based crypto core 108 may also comprise a hardware-random number generator 112 or a means to generate physical and/or software random numbers (e.g., for masks).

The components of the processing device 100 may, for example, be implemented on a single chip. The processing device 100 may be a chip card (or a chip card module) powered by direct electrical contact or through an electro-magnetic field. The processing device 100 may be a fixed circuit or based on reconfigurable hardware (e.g., Field Programmable Gate Array, FPGA). The processing device 100 may be coupled to a personal computer, microcontroller, FPGA or a smartphone System on a Chip (SoC) or other components of a smartphone. The processing device 100 may be a chip that acts as Trusted Platform Module (TPM) offering cryptographic functionality (secure storage, secure time, signature generation and validation, attestation) according to a standardized interface to a computer, smartphone, Internet of Things (IoT) device, or car.

Herein, the following notation conventions are used: The subscript i of xᵢ refers to the i-th bit of the variable x. To denote multiple bits from i to j, the notation x_{{i:j}} is used. The i-th element of a vector variable x is denoted as x[i]. Superscripts are used to access different masking shares, e.g., x^{{i:j}} accesses shares i to j. When parentheses are omitted, it implies that the entire element, whether a vector or array, is being referred to. To provide clarity on the size of the element, the size is occasionally explicitly specified in brackets.

According to various embodiments, the processing device 100 in particular performs a lattice-based cryptographic algorithm. To protect against side-channel attacks, operations are performed in a masked manner. This in particular includes the operation s⁰⊕s¹=(a⁰⊕a¹)+(b⁰⊕b¹) for operations performed in Boolean domain such as additions of Boolean-masked coefficients of polynomials or to switch between Boolean domain and arithmetic domain.

In Boolean domain, values are masked in Boolean manner, i.e. each value is represented as a (bitwise) XOR combination (or another Boolean combination) of two (or more) shares. In arithmetic domain, values are masked in an arithmetic manner, i.e. each value is represented as an arithmetic sum of two (or more) shares.

In the expression s⁰⊕s₁=(a⁰⊕a¹)+(b⁰⊕b¹), ⊕ denotes (bitwise) XOR and +denotes “normal” addition (i.e. arithmetic addition with carry). The result (i.e. the sum) s is represented as an XOR combination of the shares s⁰ and s¹, and the input values a and b are represented as an XOR combination of the shares a⁰ and a¹ and an XOR combination of the shares b⁰ and b¹, respectively.

Since this operation occurs frequently in a lattice-based cryptographic algorithm, it should be protected against faults, in particular fault attacks, while maintaining the protection against side-channel attacks (i.e. avoiding leakage of information that may occur when shares are combined). So, the challenge is to compute s⁰⊕s¹=(a⁰⊕a¹)+(b⁰⊕b¹) without recombining the shares and additionally protecting this operation against fault attacks. Unless otherwise specified, the embodiments described in detail herein assume a two-Boolean-share scenario. However, it should be noted that the approaches discussed herein are applicable to masking using more than two shares.

A straightforward approach for the fault detection is to duplicate all computations and compare the results, but this approach incurs significant overhead in terms of area and performance.

Therefore, according to various embodiments, instead of performing the Boolean masked addition s⁰⊕s¹=(a⁰⊕a¹)+(b⁰⊕b¹) two times in parallel (which is costly when maintaining side-channel protection) a checksum is calculated along with the Boolean masked addition and fault protection is achieved by checking whether the checksum fulfils a checksum condition. An example of this approach is described in the following in detail.

Let sᵢ=aᵢ⊕bᵢ⊕cᵢ be the i-th bit of the sum(s), where aᵢ and bᵢ are the bits of the input operands (a, b) and cᵢ the bit of the carry computation (c). The carry bit can be computed with cᵢ=(cᵢ₋₁∧(aᵢ⊕bᵢ))⊕(aᵢ∧bᵢ). It should be noted that c₋₁=cᵢₙ is the carry input bit (which may be set to zero). Let m be the bit length of the input operands. Then, the last bit of the carry, also known as carry output cₘ₋₁=cₒᵤₜ, IS assigned to the last bit of the sum, i.e. sₘ=cₘ₋₁. The following relation holds:

$${\sum }_{i = 0}^{m - 1} ( {a}_{i} ) + {\sum }_{i = 0}^{m - 1} ( {b}_{i} ) + {c}_{- 1} = {\sum }_{i = 0}^{m - 1} ( {s}_{i} ) + {\sum }_{i = 0}^{m - 1} ( {c}_{i} ) + {c}_{m - 1} \qquad ( 1 )$$

This relation enables the computation of checksums for the input values a and b (including the carry input bit) at the beginning of the Boolean masked addition process, which can then be compared to the checksums of the result values s and c (including the carry output bit). Typically, the intermediate carry bits are discarded, as only the final carry output bit is required for the last sum bit. However, according to one embodiment, all computed carry bits are stored until the final checksum is constructed.

In a masked setting, Equation (1) can be expressed as

$${\sum }_{i = 0}^{m - 1} ( {a}_{i}^{0} ⊕ {a}_{i}^{1} ) + {\sum }_{i = 0}^{m - 1} ( {b}_{i}^{0} ⊕ {b}_{i}^{1} ) + ( {c}_{- 1}^{0} ⊕ {c}_{- 1}^{1} ) = {\sum }_{i = 0}^{m - 1} ( {s}_{i}^{0} ⊕ {s}_{i}^{1} ) + {\sum }_{i = 0}^{m - 1} ( {c}_{i}^{0} ⊕ {c}_{i}^{1} ) + ( {c}_{m - 1}^{0} ⊕ {c}_{m - 1}^{1} ) \qquad ( 2 )$$

As mentioned above, the calculation of the carry bit involves AND combinations (denoted by ∧): cᵢ=(cᵢ₋₁∧(aᵢ⊕bᵢ))⊕(aᵢ∧bᵢ).

These AND combinations make the calculation in a masked manner (i.e. with side-channel attack protection) costly. In the following examples, the AND combination with side-channel protection is performed by a function SecAnd(.) which takes two shares per input, e.g.,

$$SecAnd ( {a}_{i}^{0} , {a}_{i}^{1} , {b}_{i}^{0} , {b}_{i}^{1} ) .$$

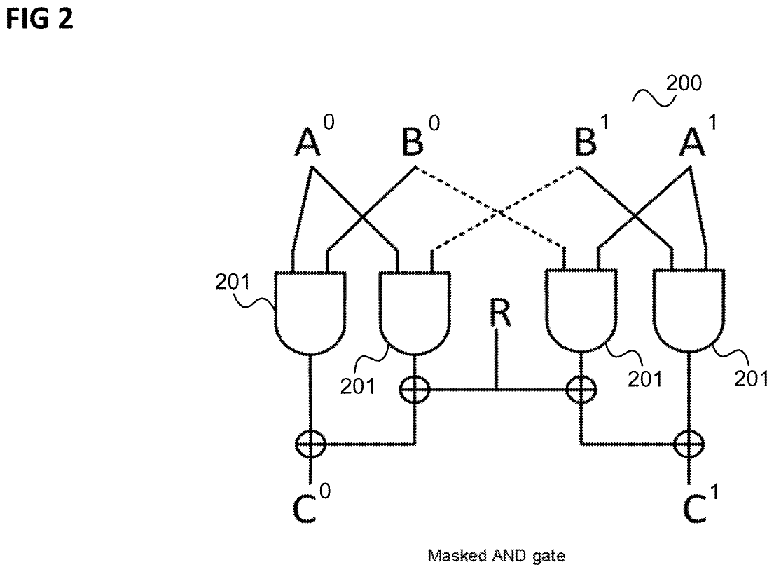

FIG. 2 illustrates an example how SecAnd(.) may be implemented in the form of a masked AND gate 200.

The inputs A and B are each split into two shares A=A⁰⊕A¹ and B=B⁰⊕B¹ and there is a remasking (by a random bit R) at domain crossing operations, where the first shares of the operands form one domain and the second shares of the operands form the other domain. Each of the four AND gates 201 receives a respective pair of the four pairs (more are possible) of one share of A and one share of B. It should be noted that none of the AND gates receives both shares of the same operand, which would lead to side-channel leakages. The (masked) output is here denoted by C=C⁰⊕C¹ and should not be confused with the carry bit mentioned above.

It can be seen that the masked AND combination is complex and thus requires a lot of processing power (in a software implementation) or a lot of chip area (in a hardware implementation), in particular when performed (at least partially in parallel) for each bit of large values (e.g., 256 coefficients of polynomials processed in the lattice-based cryptographic algorithm each with 32-bit).

Therefore, according to various embodiments, an approach is provided which allows checking the checksum condition without the necessity of performing secure AND combinations. For the actual calculation of the Boolean-masked addition, they are still necessary but their number is cut to half by enabling fault protection with the provided approach in comparison to a redundant calculation of the Boolean-masked addition.

To simplify the notation of equation (2), the individual sums can be treated as Hamming weights (HWₘ), where the Hamming weight of an m-bit integer is the number of bits set to Boolean ‘1’:

$${HW}_{m} ( {a}^{0} ⊕ {a}^{1} ) + {HW}_{m} ( {b}^{0} ⊕ {b}^{1} ) ( {c}_{- 1}^{0} ⊕ {c}_{- 1}^{1} ) = {HW}_{m + 1} ( {s}^{0} ⊕ {s}^{1} ) + {HW}_{m + 1} ( {c}^{0} ⊕ {c}^{1} ) \qquad ( 3 )$$

The Hamming weight computation is known to be a complex computation in a masked setting as it is, similar to the masked addition, a non-linear function. To break down the complexity, a computation of the checksums on bit-level is considered in the following. The relation between input and output checksums on bit-level is

$$( {a}_{i}^{0} ⊕ {a}_{i}^{1} ) + ( {b}_{i}^{0} ⊕ {b}_{i}^{1} ) + ( {c}_{i - 1}^{0} ⊕ {c}_{i - 1}^{1} ) = ( {s}_{i}^{0} ⊕ {s}_{i}^{1} ) + 2 \cdot ( {c}_{i}^{0} ⊕ {c}_{i}^{1} ) \qquad ( 4 )$$

It should be noted that the carry bit cᵢ is accounted twice, similarly to equation (2). Still, it is difficult to compute the checksums without recombining the individual shares. Equation (4) can be simplified when switching from the integers [symbol] to the finite field [symbol] ₂ (i.e. calculating the checksum modulo 2 on bit-level), leading to

$${a}_{i}^{0} ⊕ {a}_{i}^{1} ⊕ {b}_{i}^{0} ⊕ {b}_{i}^{1} ⊕ {c}_{i - 1}^{0} ⊕ {c}_{i - 1}^{1} = {s}_{i}^{0} ⊕ {s}_{i}^{1} \qquad ( 5 )$$

Reordering the variables to avoid recombinations of shares results in

$${a}_{i}^{0} ⊕ {b}_{i}^{0} ⊕ {s}_{i}^{0} ⊕ {c}_{i - 1}^{0} = {a}_{i}^{0} ⊕ {b}_{i}^{1} ⊕ {s}_{i}^{1} ⊕ {c}_{i - 1}^{1} \qquad ( 6 )$$

With the shares now clearly separated, the risk of unintended recombinations (which could leak information) is effectively eliminated.

Equation (6) necessitates operations with individual bits. However, extracting and manipulating single bits is highly inefficient on processors that operate on words. To address this issue, bitslicing can be used, e.g., to accelerate the performance of the binomial sampling in lattice-based cryptography. This technique enables the simultaneous processing of w operations in parallel, e.g., with ω=32 in a 32-bit processor architecture. To leverage the performance benefits of bitslicing, it is necessary to perform a conversion into the bitsliced domain (denoted as BitSlice) and then reverse this operation at the end (denoted as RevBitSlice). It should be noted that for w-bit operands the same function can be used for BitSlice and RevBitSlice. Let x be the bitsliced representation of the array x. While in Equation (6) bit operations where applied, the following equation operates on full processor words

â⁰[i]⊕\hat{b}⁰[i]⊕ŝ⁰[i]⊕ĉ⁰[i−1]=â¹[i]⊕\hat{b}¹[i]⊕ŝ¹[i]⊕ĉ¹[i−1] (7)

To compute the checksum for the entire Boolean masked addition, the checksums of individual bits are combined into a single sum of checksums. However, remaining in the finite field [symbol] ₂ is not suitable for this purpose, as it would lead to a loss of information. A fault that affects multiple bits may not be detected. For example, if a fault flips multiple bits in a way that preserves the parity, i.e. the sum of bits remains even or odd, the error may be undetected. To avoid this issue, computations in [symbol] are used for the sum of bits instead. This preserves more information about individual bits, leading to the following equation

$${\sum }_{i = 0}^{m - 1} ( {\hat{a}}^{0} [ i ] ⊕ {\hat{b}}^{0} [ i ] ⊕ {\hat{s}}^{0} [ i ] ⊕ {\hat{c}}^{0} [ i - 1 ] ) = {\sum }_{i = 0}^{m - 1} ( {\hat{a}}^{1} [ i ] ⊕ {\hat{b}}^{1} [ i ] ⊕ {\hat{s}}^{1} [ i ] ⊕ {\hat{c}}^{1} [ i - 1 ] ) \qquad ( 8 )$$

In lattice-based cryptography, usually complete polynomials are processed. Therefore, it is assumed that the Boolean masked addition is performed for two polynomials, a^{{0:1}}[0:n−1] and b^{{0:1}}[0:n−1] with n coefficients each. Let w represent the processor width (ω≥m), and assume that both a and b are in the bitsliced domain. Moreover, it is assumed that the addition of the coefficients does not lead to overflows, i.e. the output carry bits are always zero. Under these conditions, one obtains

$${\sum }_{j = 0}^{n / ω - 1} ( {\sum }_{i = 0}^{m - 1} ( {\hat{a}}^{0} [ ω \cdot j + i ] ⊕ {\hat{b}}^{0} [ ω \cdot j + i ] ⊕ {\hat{s}}^{0} [ ω \cdot j + i ] ⊕ {\hat{c}}^{0} [ ω \cdot j + i - 1 ] ) ) = {\sum }_{j = 0}^{n / ω - 1} ( {\sum }_{i = 0}^{m - 1} ( {\hat{a}}^{1} [ ω \cdot j + i ] ⊕ {\hat{b}}^{1} [ ω \cdot j + i ] ⊕ {\hat{s}}^{1} [ ω \cdot j + i ] ⊕ {\hat{c}}^{1} [ ω \cdot j + i - 1 ] ) ) \qquad ( 9 )$$

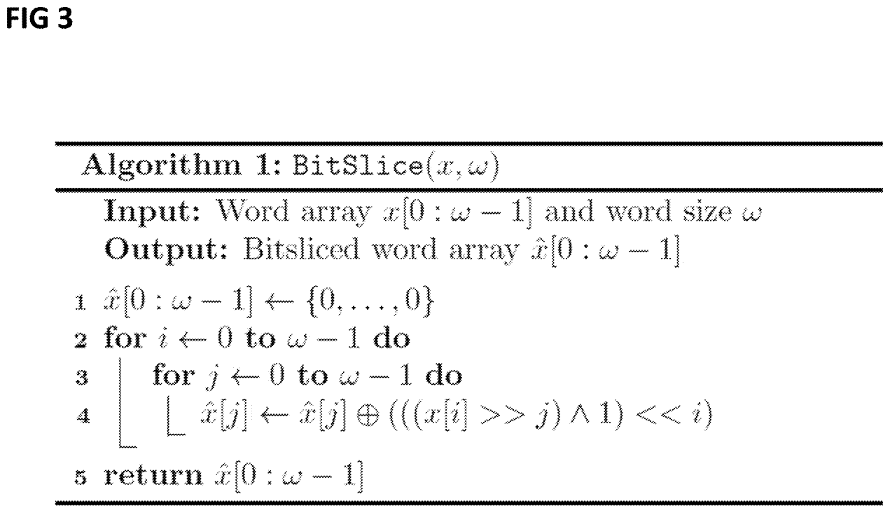

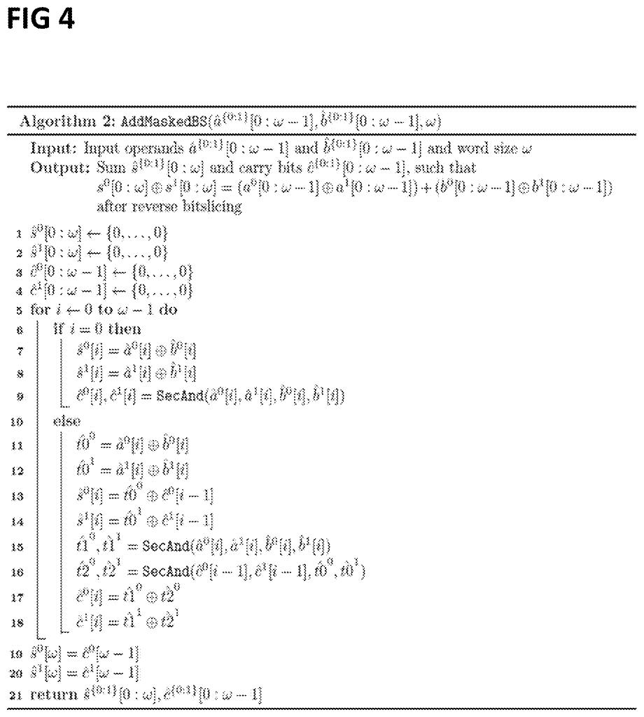

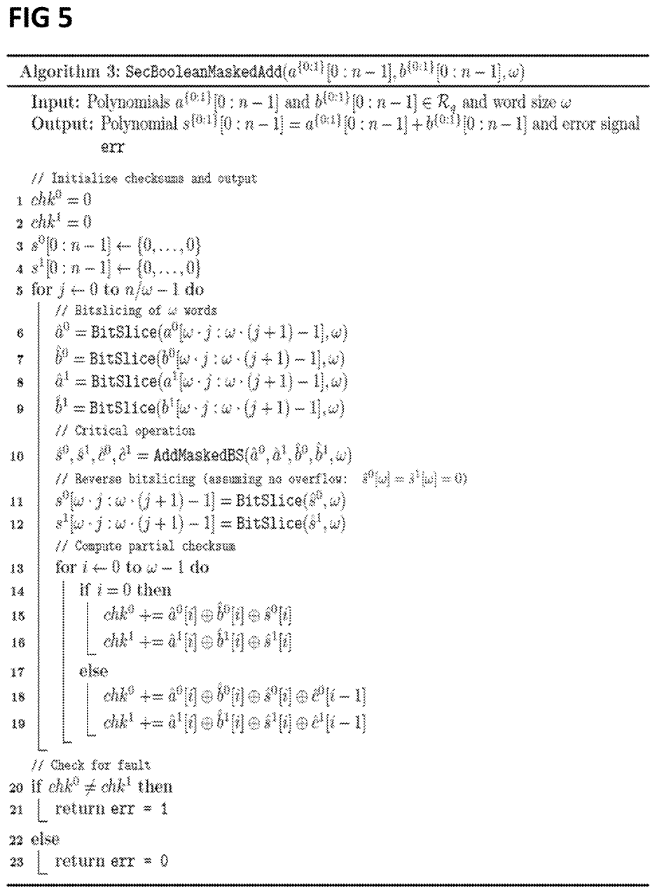

FIGS. 3, 4 and 5 show algorithms 1, 2 and 3, respectively which provide a detailed algorithmic description of the fault-protected Boolean masked addition according to an embodiment. It is here assumed that a and b are coefficient vectors (each holding n coefficients, e.g., n=256 coefficients each having 32 bit) of two polynomials. For example, the polynomials are elements of the ring [symbol] _{q}= [symbol] _{q}/φ(x) where each element in [symbol] _{q} is a polynomial of the form f(x)=f[0]+f[1]x+ . . . +f[n−1]xⁿ⁻¹. Here, q is a prime integer and n is the length of the polynomial, typically chosen to be a power of two, i.e. n=2^{k} Each coefficient f[i] is an element of the field [symbol] _{q}.

Algorithm 1 and algorithm 2 serve as supporting algorithms for the main algorithm, algorithm 3. Algorithm 1 is responsible for converting an array between the normal domain and the bitsliced domain. It takes as input a word array x[0:ω−1] with ω elements, where each element is a w-bit value. For simplicity, it is assumed in the following that the word length is equal to the input operand length (m=ω).

For example, the input array might consist of 32 coefficients, each with 32 bits. The algorithm initializes the output array in line 1. The nested loops in lines 2-4 perform the bitslicing operation, which rearranges the bits of the input array. Specifically, the first bit of all coefficients is mapped to a single output array element, the second bit to another element, and so on. The j-th bit of the i-th input word (i.e. of x[i]) is put into the j-th word of the output array (i.e. into \hat{x}[j]) at the i-th position. The resulting bitsliced array \hat{x} is returned in line 5.

Algorithm 2 is the critical operation that requires fault protection. It performs the Boolean masked addition of two input arrays, serving as an example realization of a ripple-carry adder. However, embodiments are not limited to this specific type of adder.

Algorithm 2 relies on a SecAnd function as mentioned above, which securely computes the values z⁰ and z¹ such that z⁰⊕z¹=(x⁰⊕x¹)∧(y⁰⊕y¹) without recombining the two masking shares. As illustrated in FIG. 2, this can be achieved using fresh randomness (i.e. remasking). Algorithm 2 takes as input the parameter w and the two operands â^{{0:1}}[0:ω−1] and \hat{b}^{{0:1}}[0:ω−1], which are assumed to be in the bitsliced domain. In lines 1-4, the output sum ŝ^{{0:1}}[0:ω] and the respective carry bits ĉ^{{0:1}}[0:ω−1] are initialized. The core of algorithm 2 can be seen to be the loop in lines 5-18, which computes the sum and carry bits (in bitsliced format) according to the equations presented above.

The computations of the first round of the loop (i=0) can be simplified if the carry-in bits are set to zero. Algorithm 2 not only considers carry propagation but also stores the carry values for each round. In lines 19-20, the carry output is assigned to the last sum bits for the first and second shares, respectively. Finally, in line 21, the bitsliced sum and carry arrays are returned.

Algorithm 3 is the primary algorithm for the protected Boolean masked addition. It takes as input two polynomials, a^{{0:1}}[0:n−1] and b^{{0:1}}[0:n−1], which are the input operands for the addition, and are elements of [symbol] _{q}. Additionally, it takes as input the parameter ω, which represents the bit width of the processor. Algorithm 3 initializes the two shares for the checksums and the output sum of the addition in lines 1-4. The sum is computed in chunks of ω coefficients in the loop spanning lines 5-19. Within this loop, both shares of the input operands are transformed into the bitsliced domain in lines 6-9, which can be done inplace since the operands in the normal domain are no longer required. The next step is the computation of the Boolean masked addition in line 10, which yields the sum ŝ^{{0:1}}[0: ω] and the carry bits ĉ^{{0:1}}[0:ω−1] in the bitsliced domain.

In should be noted that the carry-out bits are typically zero if the input operands have at most ω−1 bits, ŝ^{{0:1}}[ω] is discarded for simplicity. Lines 11-12 reverse the bitsliced representation to obtain the sum in the normal domain for both masking shares. The resulting ω coefficients s^{{0:1}}[0:ω−1] are assigned to the output sum. The checksum computations follow in lines 13-19. The final checksums chk⁰ and chk¹ are incrementally updated for each element of the input vectors and output vectors. Since the carry input bits are zero in this example, the operations for the first loop (i=0) are simplified. Finally, in lines 20-23, the checksums chk⁰ and chk¹ are compared. If they are identical, the algorithm returns no error. Otherwise, an error is returned.

It is worth noting that the final comparison is not vulnerable to side-channel attacks, unlike the case where fault protection is achieved through duplication (i.e. redundant calculation). Additionally, algorithm 3 is well-suited to integrate additional countermeasures, such as shuffling at the for-loops or random rotation of the operands during the checksum calculation (lines 14-19).

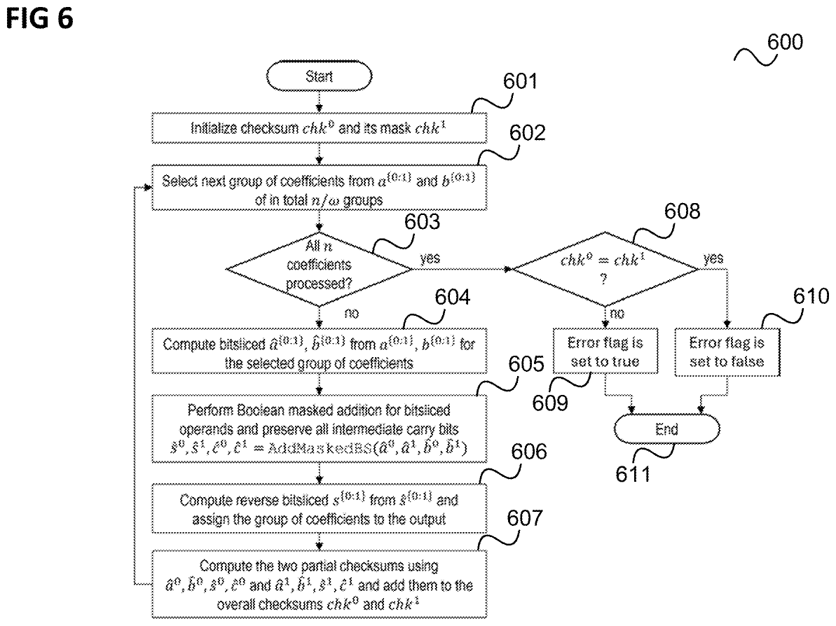

FIG. 6 shows a flow diagram 600 which illustrates the flow of the complete algorithm for performing fault-protected Boolean masked addition according to an embodiment (e.g., including algorithms 1 to 3).

In 601, the (overall) checksum components are initialized.

In 602, a loop over groups of coefficients (according to dimension of the bitslicing) is started which is exited in 603 when all coefficients have been processed.

For each iteration of the loop, the coefficients are bitsliced in 604 and Boolean masked addition is performed in 605. In 606, reverse bitslicing of the result is performed and the two partial checksums (for the current group of coefficients) are determined and added to the overall checksum components in 607.

When the loop is exited, the overall checksum components are compared to each other 608 and an error flag is set in 609 if there is a mismatch and in 610 the error flag is not set if there is a match and the Boolean masked addition process ends in 611. If the error flag is set, a security measure is for example triggered like that the result of the Boolean masked addition is discarded and the Boolean masked addition is repeated, or an alarm is raised, or the device is reset, etc.

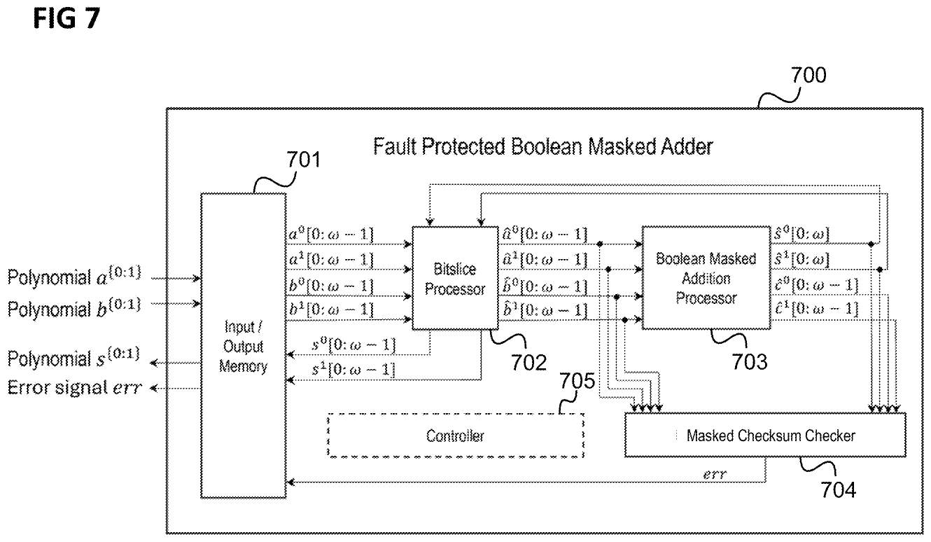

FIG. 7 shows a hardware device 700 for performing the fault-protected Boolean masked addition as described above, i.e. a fault-protected Boolean masked adder.

It includes an input/output memory 701, a bitslice processor 702, a Boolean masked addition processor 703 and a masked checksum checker 704 (including in particular a masked checksum calculator). A controller 705 makes these components perform the fault-protected Boolean masked addition as described above. Specifically, the bitslice processor 702 for example performs algorithm 1, the Boolean masked addition processor 703 for example performs algorithm 2 and the masked checksum checker 704 for example performs algorithm 3. The masked checksum checker 704 may thus be seen to implement a fault protection circuit.

In summary, according to various embodiments, a data processing device (e.g., a security device) is provided (e.g., corresponding to the processing device 100 or the hardware device 700), comprising
a Boolean masked addition processor (e.g., corresponding to Boolean masked addition processor 703) configured to perform a Boolean masked addition of input values to generate a result value, wherein each input value has a bit for each bit position of a plurality of bit positions and is represented by a Boolean combination of two or more respective shares, the result value has a bit for each bit position of the plurality of bit positions and is represented by a Boolean combination of two or more respective shares and carry bits occurring in the addition are each represented by a Boolean combination of two or more respective shares and
a fault protection circuit (e.g., corresponding to masked checksum checker 704) configured to
   calculate, per bit position, a sum of the bits of the first shares of the input values and the bit of the first share of the result value and the first share of a carry bit (carried to the bit position, it is frequently zero for the first bit position) modulo 2 (see left hand side of equation (6)) and generating a first checksum-share by accumulating the calculated sums over the bit positions (see left hand side of equation (8)). Accumulating the calculated sum means calculating the sum of the calculated sums.
   calculate, per bit position, a sum of the bits of the second shares of the input values and the bit of the second share of the result value and the second share of a carry bit (carried to the bit position, it is frequently zero for the first bit position) modulo 2 (see right hand side of equation (6)) and generating a second checksum-share by accumulating the calculated sums over the bit positions (see right hand side of equation (8)).
   compare the first checksum-share with the checksum for the second share and
   trigger a security measure in reaction to a mismatch between the first checksum-share and the second checksum-share.

According to various embodiments, in other words a fault countermeasure for Boolean masked addition is provided resulting in a Boolean masked addition with combined security against fault and side-channel attacks. The approach is based on storing intermediate results of the carry computation, enabling the creation of checksums for input operands and output of the secure addition. It is further based on an efficient ordering of masking shares to prevent unintended recombinations, achieved through effective switching between [symbol] and [symbol] ₂. Information about bit-level comparisons are preserved, ensuring effective fault detection. Optionally, bitslicing may be used for increased performance.

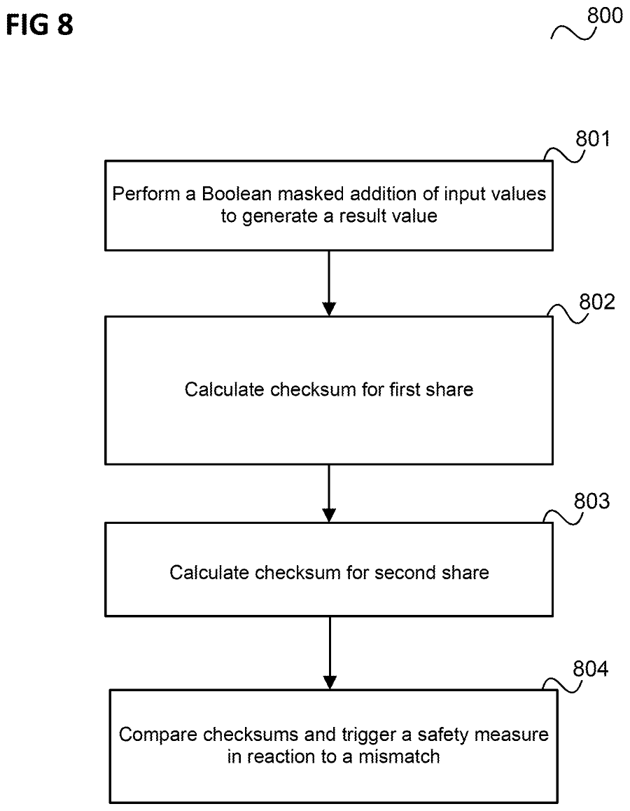

According to an embodiment, a method is provided as illustrated in FIG. 8.

FIG. 8 shows a flow diagram 800 illustrating a method for protecting a Boolean masked addition against faults according to an embodiment.

In 801, a Boolean masked addition of input values is performed to generate a result value. Each input value has a bit for each bit position of a plurality of bit positions and is represented by a Boolean (e.g. XOR) combination of two or more respective shares. The result value has a bit for each bit position of the plurality of bit positions and is represented by a Boolean (e.g. XOR) combination of two or more respective shares. Carry bits occurring in the addition are each represented by a Boolean (e.g. XOR) combination of two or more respective shares, too. It should be noted that typically, the same Boolean combination (e.g. XOR) is used for the input values, the result value and the carry bits.

In 802, the sum of the bits of the first shares of the input values and the bit of the first share of the result value and the first share of a carry bit is calculated per bit position modulo 2 and a first checksum-share (i.e. a checksum for the first shares) is calculated by accumulating the calculated sums over the bit positions.

In 803 the sum of the bits of the second shares of the input values and the bit of the second share of the result value and the second share of a carry bit is calculated per bit position modulo 2 and a second checksum-share (i.e. a checksum for the second shares) is calculated by accumulating the calculated sums over the bit positions.

In 804, the first checksum-share is compared with the second checksum-share and a security measure is triggered in reaction to a mismatch between the first checksum-share and the second checksum-share.

Various Examples are described in the following:
Example 1 is a data processing device as described above (subsequent to the description of FIG. 7).
Example 2 is the data processing device of example 1, comprising an input configured to receive an array of first input values comprising an input value for each of a plurality of input value positions and an array of second input values comprising an input value for each of the plurality of input value positions, wherein the Boolean masked addition processor is configured to perform the Boolean masked addition for each input value position, wherein the input values for the Boolean masked addition for each input value position comprises the input value of the array of the first input values at the input value position and the input value of the array of the second input values at the input value position (see, e.g., output of Algorithm 2: the input array a and the input array b are added for each position (index 0, . . . , ω)).
Example 3 is the data processing device of example 2, comprising a bitslice processor to convert the array of first input values and the array of second input values to bitsliced domain.
Example 4 is the data processing device of example 3, wherein the Boolean masked addition processor and the fault protection circuit are configured to operate on the input values in bitsliced domain.
Example 5 is the data processing device of example 3 or 4, wherein the Boolean masked addition processor is configured to perform the Boolean masked addition in parallel for multiple input value positions.
Example 6 is the data processing device of any one of examples 2 to 5, wherein the fault protection circuit is configured to generate the first checksum-share, generate the second checksum-share, compare the first checksum-share with the second checksum-share and trigger a security measure in reaction to a mismatch between the first checksum-share and the second checksum-share for each Boolean masked addition that the Boolean masked addition processor performs for an input value position of the plurality of input value positions.
Example 7 is the data processing device of example 6, wherein the fault protection circuit is configured to generate the first checksum-share, generate the second checksum-share, compare the first checksum-share with the second checksum-share in parallel for multiple Boolean masked additions that the Boolean masked addition processor performs for multiple input value positions of the plurality of input value positions.
Example 8 is the data processing device of any one of examples 2 to 7, wherein the array of first input values is an array of coefficients of a first polynomial and the array of second input values is an array of coefficients of a second polynomial.
Example 9 is the data processing device of any one of examples 1 to 8, wherein the input values comprise two operands and an input carry bit.
Example 10 is the data processing device of any one of examples 1 to 9, wherein the result value is represented as truncated result value (truncated to the bit size of the input values, i.e. the most significant bit is missing) and an output carry bit.
Example 11 is the data processing device of any one of examples 1 to 10, wherein the data processing device is configured to perform a cryptographic algorithm and to perform the Boolean masked addition as part of a processing operation of the cryptographic algorithm.
Example 12 is the data processing device of example 11, wherein the processing operation is a conversion between Boolean masking and arithmetic masking.
Example 13 is the data processing device of example 11 or 12, wherein the cryptographic algorithm is a lattice-based cryptographic algorithm.
Example 14 is the data processing device of any one of examples 1 to 13, wherein the security measure is a security measure against a fault attack.
Example 15 is a method as described with reference to FIG. 8.

The components of the data processing device (in particular the Boolean masked addition processor and the fault protection circuit) and the method of FIG. 8 may be performed by a data processing device (e.g., computer or microcontroller) having one or more data processing units or processors and one or more memories (storing data to be processed and instructions according to which the data is processed). The term “data processing unit” and “processor” may be understood to mean any type of entity that enables the processing of data or signals. For example, the data or signals may be handled according to at least one (i.e. one or more than one) specific function performed by the data processing unit. A data processing unit or processor may include or be formed from an analog circuit, a digital circuit, a logic circuit, a microprocessor, a microcontroller, a central processing unit (CPU), a graphics processing unit (GPU), a digital signal processor (DSP), a field programmable gate array (FPGA), or any combination thereof. Any other means for implementing the respective functions described in more detail herein may also be understood to include a data processing unit, processor or logic circuitry. One or more of the method steps described in more detail herein may be performed (e.g., implemented) by a data processing unit or processor through one or more specific functions performed by the data processing unit.

According to an embodiment, a data processing device is provided comprising Boolean masked addition means for performing a Boolean masked addition of input values to generate a result value, wherein each input value has a bit for each bit position of a plurality of bit positions and is represented by a Boolean combination of two or more respective shares, the result value has a bit for each bit position of the plurality of bit positions and is represented by a Boolean combination of two or more respective shares and carry bits occurring in the addition are each represented by a Boolean combination of two or more respective shares,

calculation means for calculating, per bit position, a sum of the bits of the first shares of the input values and the bit of the first share of the result value and the first share of a carry bit modulo 2 and for generating a first checksum-share by accumulating the calculated sums over the bit positions and for calculating, per bit position, a sum of the bits of the second shares of the input values and the bit of the second share of the result value and the second share of a carry bit modulo 2 and for generating a first checksum-share by accumulating the calculated sums over the bit positions, and security means for comparing the first checksum-share with the second checksum-share and for triggering a security measure in reaction to a mismatch between the first checksum-share and the second checksum-share.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A data processing device, comprising:
a Boolean masked addition processor configured to perform a Boolean masked addition of input values to generate a result value, wherein each input value has a bit for each bit position of a plurality of bit positions and is represented by a Boolean combination of two or more respective shares, the result value has a bit for each bit position of the plurality of bit positions and is represented by a Boolean combination of two or more respective shares and carry bits occurring in the addition are each represented by a Boolean combination of two or more respective shares;
a fault protection circuit configured to
calculate, per bit position, a sum of the bits of the first shares of the input values and the bit of the first share of the result value and the first share of a carry bit modulo 2 and generating a first checksum-share by accumulating the calculated sums over the bit positions;
calculate, per bit position, a sum of the bits of the second shares of the input values and the bit of the second share of the result value and the second share of a carry bit modulo 2 and generating a second checksum-share by accumulating the calculated sums over the bit positions;
compare the first checksum-share with the second checksum-share;
trigger a security measure in reaction to a mismatch between the first checksum-share and the second checksum-share.

2. The data processing device of claim 1, comprising an input configured to receive an array of first input values comprising an input value for each of a plurality of input value positions and an array of second input values comprising an input value for each of the plurality of input value positions, wherein the Boolean masked addition processor is configured to perform the Boolean masked addition for each input value position, wherein the input values for the Boolean masked addition for each input value position comprises the input value of the array of the first input values at the input value position and the input value of the array of the second input values at the input value position.

3. The data processing device of claim 2, comprising a bitslice processor to convert the array of first input values and the array of second input values to bitsliced domain.

4. The data processing device of claim 3, wherein the Boolean masked addition processor and the fault protection circuit are configured to operate on the input values in bitsliced domain.

5. The data processing device of claim 3, wherein the Boolean masked addition processor is configured to perform the Boolean masked addition in parallel for multiple input value positions.

6. The data processing device of claim 2, wherein the fault protection circuit is configured to generate the first checksum-share, generate the second checksum-share, compare the first checksum-share with the second checksum-share and trigger a security measure in reaction to a mismatch between the first checksum-share and the second checksum-share for each Boolean masked addition that the Boolean masked addition processor performs for an input value position of the plurality of input value positions.

7. The data processing device of claim 6, wherein the fault protection circuit is configured to generate the first checksum-share, generate the second checksum-share, compare the first checksum-share with the second checksum-share in parallel for multiple Boolean masked additions that the Boolean masked addition processor performs for multiple input value positions of the plurality of input value positions.

8. The data processing device of claim 2, wherein the array of first input values is an array of coefficients of a first polynomial and the array of second input values is an array of coefficients of a second polynomial.

9. The data processing device of claim 1, wherein the input values comprise two operands and an input carry bit.

10. The data processing device of claim 1, wherein the result value is represented as truncated result value and an output carry bit.

11. The data processing device of claim 1, wherein the data processing device is configured to perform a cryptographic algorithm and to perform the Boolean masked addition as part of a processing operation of the cryptographic algorithm.

12. The data processing device of claim 11, wherein the processing operation is a conversion between Boolean masking and arithmetic masking.

13. The data processing device of claim 11, wherein the cryptographic algorithm is a lattice-based cryptographic algorithm.

14. The data processing device of claim 1, wherein the security measure is a security measure against a fault attack.

15. A method for protecting a Boolean masked addition against faults, comprising:
performing a Boolean masked addition of input values to generate a result value, wherein each input value has a bit for each bit position of a plurality of bit positions and is represented by a Boolean combination of two or more respective shares, the result value has a bit for each bit position of the plurality of bit positions and is represented by a Boolean combination of two or more respective shares and carry bits occurring in the addition are each represented by a Boolean combination of two or more respective shares;
calculating, per bit position, a sum of the bits of the first shares of the input values and the bit of the first share of the result value and the first share of a carry bit modulo 2 and generating a first checksum-share by accumulating the calculated sums over the bit positions;
calculating, per bit position, a sum of the bits of the second shares of the input values and the bit of the second share of the result value and the second share of a carry bit modulo 2 and generating a second checksum-share by accumulating the calculated sums over the bit positions;
comparing the first checksum-share with the second checksum-share;
triggering a security measure in reaction to a mismatch between the first checksum-share and the second checksum-share.
